(19) United States
(12) Patent Application Publication
(10) Pub. No.: US 2025/0266643 A1
(43) Pub. Date: Aug. 21, 2025

(54) PLUG CONNECTOR WITH IMPROVED OPERATIONAL SAFETY, IN PARTICULAR AT HIGH ELECTRICAL VOLTAGES

(71) Applicant: HARTING ELECTRIC STIFTUNG & CO. KG, Espelkamp (DE)

(72) Inventors: Norbert KROPIEWNICKI, Bielefeld (DE); Wilhelm KLIEVER, Minden (DE)

(21) Appl. No.: 19/045,429

(22) Filed: Feb. 4, 2025

(30) Foreign Application Priority Data
Feb. 15, 2024 (DE) 10 2024 104 291.5

(51) Int. Cl. H01R 13/53; H01R 13/504; H01R 13/516; H01R 13/58

(52) U.S. Cl. CPC H01R 13/53; H01R 13/504; H01R 13/516; H01R 13/58

(57) ABSTRACT

A plug connector is provided, the plug connector at least having a plug connector housing, an insulating body and a contact element, wherein the insulating body has at least one semiconductive area for the purpose of field control.

### BACKGROUND

### Technical Field

The present disclosure is related to plug connectors, such as plug connectors that are used in particular in the rail industry for transmitting high currents and/or when medium to high voltages are employed, for example, in the case of wind turbines.

### Description of the Related Art

DE 101 40 762 A1 discloses an angled plug connector which has an integrated fuse for the purpose of avoiding undesired partial discharges.

The structure of this angled plug connector is, however, very complex such that production is very expensive. Moreover, the angled plug connector cannot be used any more once the fuse has been triggered. It must first be replaced.

### BRIEF SUMMARY

Embodiments of the present disclosure provide a plug connector in which as few partial discharges as possible occur and which can be produced simply.

The plug connector according to the disclosure has at least a plug connector housing, an insulating body and a contact element. The insulating body has a semiconductive area for field control. The semiconductive area or field control area is provided to prevent an undesired partial discharge.

The insulating body is advantageously produced in a two-component injection-molding process. As a result, the abovementioned field control area can be provided in a single process step on the injection-molded part, namely, on the insulating body.

The insulating body advantageously comprises or consists of two plastic materials with in each case different electrical conductivities. One material here preferably has very good insulating properties, whilst the other material has semiconductive properties.

The material with semiconductive properties may be a conductive plastic, in particular a polyethylene with a high molecular weight, which has electrically conductive properties.

In short, it can overall be stated that the field control area is made from a different material than the remainder of the insulating body. The field control area is locally delimited.

The plug connector may include a two-part contact element. The contact element may be formed from a terminal part and from a contact part.

The terminal part may have on one side an axial opening which is designed as a crimp terminal for an electrical conductor. At the other end, the terminal part may have a radial through opening into which the contact part can be inserted. The contact part may be designed, for example, as a pin contact.

A circumferential contact strip may be arranged inside the through opening. Reliable electrical contact between the terminal part and the contact part may be ensured as a result.

The terminal part and the contact part may be oriented approximately at right angles or orthogonally to each other. As a result, the plug connector can be configured as angled, wherein the cable connection direction and the plugging direction intersect at a 90° angle.

In an advantageous embodiment, the terminal part is arranged in the semiconductive area of the insulating body. Partial discharges may be effectively avoided as a result.

The angled area of intersection of the contact element may be arranged in the semiconductive area of the insulating body. Because of its angular geometry, the area of intersection may present a high risk of partial discharges which are thus effectively reduced or avoided.

The insulating body may be designed in at least two parts. Complex semiconductive areas can be geometrically implemented by virtue of the two-part form.

At least two parts of the insulating body may be advantageously produced in each case in a two-component injection-molding process. One material can here be processed for the semiconductive area and a different material for the remainder of the insulating body in a single working step or a single injection mold.

At least two parts of the insulating body may comprise or consist in each case of two plastic materials with in each case different electrical conductivities. As a result, complex geometries of semiconductive areas can be realized.

In an advantageous variant of the disclosure, the insulating body is designed in three parts. As a result, complex geometries of semiconductive areas can be realized at the same time as a saving in material.

At least one part of the insulating body may comprise or consist of two different plastic materials and at least one part of the insulating body may have a homogeneous design and may comprise or consist uniformly of the same plastic material. Expressed differently, at least one part of the insulating body may have two different areas which are formed from different plastic materials and at least one other part of the insulating body may comprise or consist of a single plastic material.

At least two parts of the insulating body may comprise or consist in each case of two different plastic materials. At least one part of the insulating body may have a homogeneous design and comprise or consist of the same plastic material. The latter part may comprise or consist of an insulating plastic which is usually provided for insulating bodies. Expressed differently, at least two parts of the insulating body may have in each case two different areas which are formed from different plastic materials and at least one other part of the insulating body may comprise or consist of a single plastic material.

### BRIEF DESCRIPTION OF THE SEVERAL VIEWS OF THE DRAWINGS

An exemplary embodiment of the disclosure is illustrated in the drawings and will be explained in more detail below.

FIG. 1 shows a perspective view in section of a plug connector according to an embodiment of the disclosure,

FIG. 2 shows a perspective view of a first part of an insulating body of the plug connector which is produced in a two-component injection-molding process,

FIG. 3 shows a further perspective view of the first part of the insulating body which is produced in the two-component injection-molding process,

FIG. 4 shows a perspective view of a second part of the insulating body which is produced in the two-component injection-molding process,

FIG. 5 shows a perspective view of a third part of the insulating body,

FIG. 6 shows a further perspective view of the third part of the insulating body,

FIG. 7 shows a perspective view in section of the whole insulating body of the plug connector, and

FIG. 8 shows a two-part contact element of the plug connector.

The figures may contain partially simplified, schematic illustrations. To some extent, identical reference signs are used for elements that are similar but might not be identical. Different views of the same elements may be drawn to different scales. Directional indications such as, for example, “left,” “right,” “top” and “bottom” should be understood with reference to the figure in question and may vary in the individual illustrations in relation to the object illustrated.

### DETAILED DESCRIPTION

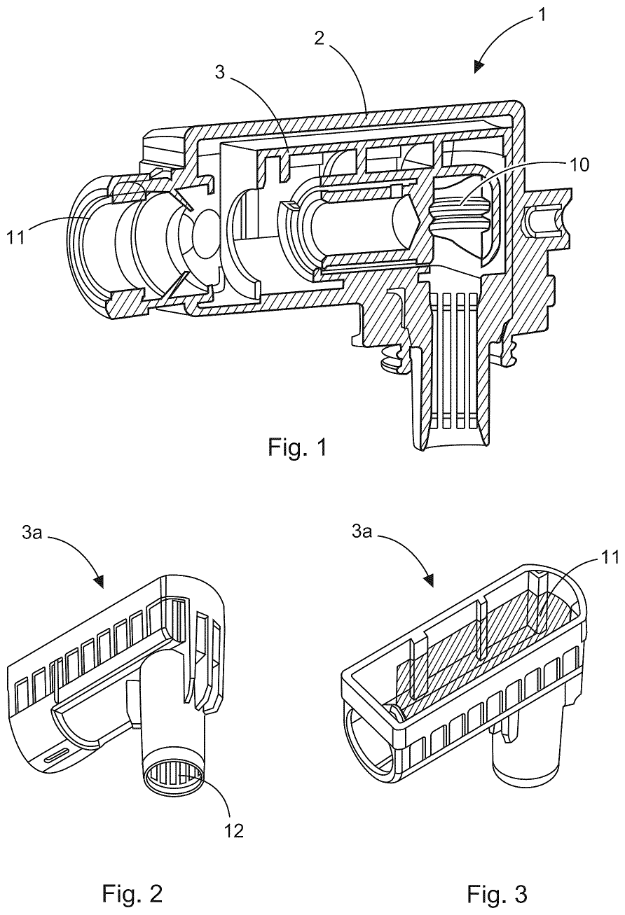

FIG. 1 shows a view in section of a plug connector 1 configured according to an embodiment of the present disclosure. The plug connector 1 has a plug connector housing 2 in which an insulating body 3 is arranged. The plug connector housing 2 may consist essentially of aluminum.

A two-part contact element 4 comprising or consisting of a terminal part 4a and a contact part 4b is arranged inside the insulating body 3. The terminal part 4a has at one end an axial opening 5 which is provided as a crimp terminal for the connection of an electrical conductor (not shown). At the other end, the terminal part 4a has a radial through opening 6 into which the contact part 4b can be inserted or through which it can be passed. The geometry of the contact part 4b is not an essential part of the disclosure such that the contact part 4b in FIG. 3 is illustrated only schematically.

The terminal part 4a and the contact part 4b of the contact element 4 are arranged essentially orthogonally to each other. As a result, the plug connector 1 can be configured as angled, wherein the cable connection direction and the plugging direction intersect at a 90° angle.

Optionally, the plug connector 1 can have a partial discharge sleeve 7 which is illustrated only in FIG. 8. In the assembled state, the terminal part 4a of the contact element 4 is arranged in this alternative embodiment inside the partial discharge sleeve 7. There is, however, no need for a partial discharge sleeve 7 by virtue of the insulating body 3 according to embodiments of the present disclosure which has already been described in detail above.

The partial discharge sleeve 7 has a push-in opening 9. The terminal part 4a can be pushed into the partial discharge sleeve 7. The partial discharge sleeve 7 has a contact opening 8 which correlates with the through opening 6 of the terminal part 4a. As a result, the contact part 4b can furthermore be pushed into the terminal part 4a.

A circumferential contact strip 10 is arranged inside the through opening 6 of the terminal part 4a. A reliable electrically conductive connection between the terminal part 4a and the contact part 4b is produced by the contact strip 10.

A first part 3a of the insulating body 3 according to an embodiment of the present disclosure is illustrated in FIGS. 2 and 3. The first part 3a is produced in a two-component injection-molding process and has a semiconductive area 11 which is formed from a semiconductive or conductive plastic, in particular from polyethylene. The remaining part of the first part 3a consists of a different material which in particular has good insulating properties.

The first part 3a of the insulating body 3 has a hollow cylindrical opening 12 in which the contact part 4b of the contact element 4 runs. The terminal part 4a of the contact element 4 is positioned on the semiconductive area 11.

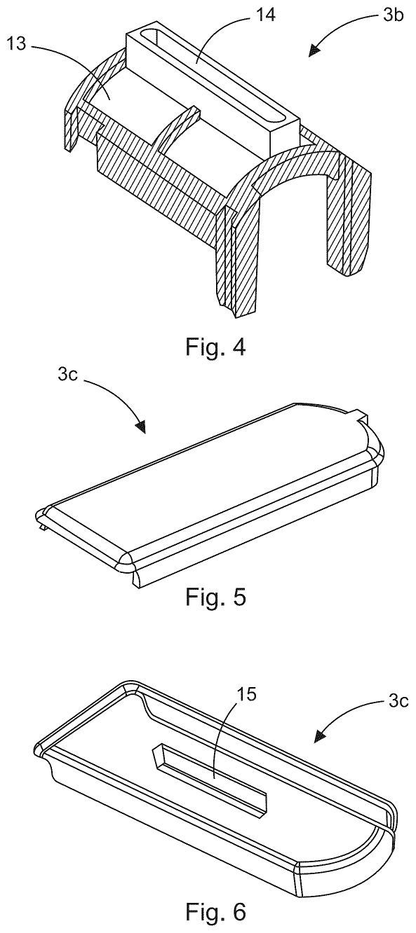

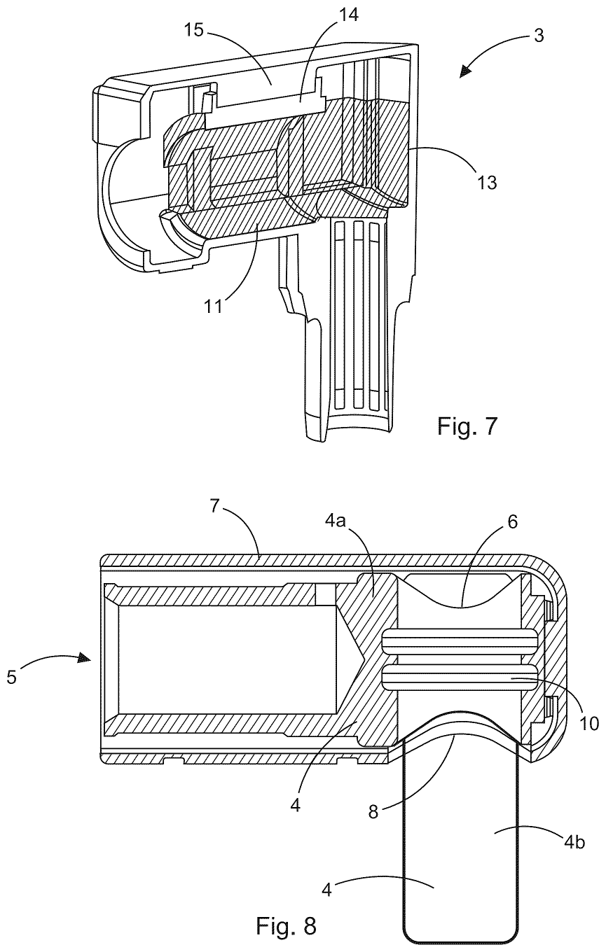

A second part 3b of the insulating body 3 is illustrated in perspective in FIG. 4. The second part 3b is produced in a two-component injection-molding process and has a semiconductive area 13 which is formed from a semiconductive or conductive plastic, in particular from polyethylene. The remaining insulating area 14 consists of a different material which in particular has good insulating properties.

The second part 3b of the insulating body 3 sits on the semiconductive area 11 of the first part 3a of the insulating body 3 such that the semiconductive areas 11, 13 enclose the terminal part 4a of the contact element, including the area of intersection between the terminal part 4a and the contact part 4b. As a result, a partial discharge in this contact element area which is geometrically prone to it is effectively avoided.

A third part 3c of the insulating body 3 is illustrated in perspective in FIG. 5. The third part 3c functions as the cover of the insulating body 3. The third part 3c comprises or consists completely of a single insulating plastic material.

The third part 3c of the insulating body 3 has a fixing rib 15 on the inside which, in the assembled state, engages in the insulating area 14 of the second part 3b of the insulating body 3.

In the assembled state, the contact element 4 or its terminal part 4a is arranged between the first part 3a and the second part 3b of the insulating body 3 or fixed between them. The terminal part 4a is thus shielded from the semiconductive areas 11, 13 of the insulating body 3 in terms of field control. The whole system is fixed together via the third part 3c or the cover of the insulating body 3.

At the cable terminal, the plug connector 1 has a cable outlet 11 which performs a sealing and strain-relief function for the connected cable (not shown).

Even though various aspects or features of the disclosure are respectively shown in combination in the figures, it is clear to a person of ordinary skill in the relevant art that—unless otherwise stated—the combinations shown and discussed are not the only ones possible. In particular, mutually corresponding units or complexes of features from different exemplary embodiments can be interchanged with one another. In other words, aspects of the various embodiments described above can be combined to provide further embodiments.

German patent application no. 10 2024 104 291.5, filed Feb. 15, 2024, to which this application claims priority, is hereby incorporated herein by reference in its entirety.

In general, in the following claims, the terms used should not be construed to limit the claims to the specific embodiments disclosed in the specification and the claims, but should be construed to include all possible embodiments along with the full scope of equivalents to which such claims are entitled.

1. A plug connector, at least having a plug connector housing, an insulating body and a contact element, wherein the insulating body has at least one semiconductive area for the purpose of field control.

2. The plug connector according to claim 1, wherein the insulating body is produced in a two-component injection-molding process.

3. The plug connector according to claim 1, wherein the insulating body consists of two plastic materials with in each case different electrical conductivities.

4. The plug connector according to claim 1, wherein the plug connector has a two-part contact element which is formed from a terminal part and a contact part.

5. The plug connector according to claim 4, wherein the terminal part has at one end an axial opening which is designed as a crimp terminal for an electrical conductor, and wherein the terminal part has at the other end a radial through opening into which the contact part is insertable.

6. The plug connector according to claim 5, wherein a circumferential contact strip is arranged inside the radial through opening.

7. The plug connector according to claim 4, wherein the terminal part and the contact part are oriented approximately at right angles to each other.

8. The plug connector according to claim 7, wherein an angled area of intersection of the contact element is arranged in the at least one semiconductive area of the insulating body.

9. The plug connector according to claim 4, wherein the terminal part is arranged in the at least one semiconductive area of the insulating body.

10. The plug connector according to claim 1, wherein the insulating body is designed in at least two parts.

11. The plug connector according to claim 10, wherein at least two parts of the insulating body are in each case produced in a two-component injection-molding process.

12. The plug connector according to claim 10, wherein at least two parts of the insulating body consist in each case of two plastic materials with different electrical conductivities.

13. The plug connector according to claim 1, wherein the insulating body is designed in at least three parts.

14. The plug connector according to claim 13, wherein at least one part of the insulating body has two different areas which are formed from different plastic materials, and at least one other part of the insulating body consists of a single plastic material.

15. The plug connector according to claim 13, wherein at least two parts of the insulating body have in each case two different areas which are formed from different plastic materials, and at least one other part of the insulating body consists of a single plastic material.
